(19) United States
(12) Patent Application Publication
(10) Pub. No.: US 2024/0220855 A1
(43) Pub. Date: Jul. 4, 2024

(54) JOINT MACHINE LEARNING AND DYNAMIC OPTIMIZATION WITH TIME SERIES DATA TO FORECAST OPTIMAL DECISION MAKING AND OUTCOMES OVER MULTIPLE PERIODS

(71) Applicant: INTERNATIONAL BUSINESS MACHINES CORPORATION, Armonk, NY (US)

(72) Inventors: Zhengliang Xue, Yorktown Heights, NY (US); Mo Liu, Albany, CA (US); Shivaram Subramanian, Frisco, TX (US); Markus Ettl, Yorktown Heights, NY (US)

(21) Appl. No.: 18/148,926

(22) Filed: Dec. 30, 2022

(51) Int. Cl. G06N 20/00

(52) U.S. Cl. CPC G06N 20/00

(57) ABSTRACT

A total demand model can be trained, by machine learning and using historical data. The total demand model can be configured to process current data and output first data indicating a predicted future total demand for a product. A target demand model can be trained. The target demand model can be configured to process the current data and, based on processing the current data, output a plurality of class demand models. Each class demand model can be configured to predict demand, for each of a plurality of future time periods, for a plurality of classes of the product. The class demand models configured to optimize, for each of the plurality of future time periods, a respective set of optimal prices for the respective classes of the product that maximizes total expected revenue for the product over the plurality of classes of the product.

### BACKGROUND

The present invention relates to machine learning.

Machine learning is a branch of artificial intelligence (AI) and computer science. Machine learning involves the use and development of computer systems that are able to learn and adapt without following explicit instructions. Aspects of machine learning utilize algorithms and statistical models to analyze and draw inferences from patterns in data.

### SUMMARY

A method can include training, by machine learning implemented using a processor and using historical data, a total demand model configured to process current data and, based on processing the current data, output first data indicating a predicted future total demand for a product. The method also can include training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

A system includes a processor programmed to initiate executable operations. The executable operations can include training, by machine learning and using historical data, a total demand model configured to process current data and, based on processing the current data, output first data indicating a predicted future total demand for a product. The executable operations also can include training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

A computer program product includes one or more computer readable storage mediums having program code stored thereon. The program code stored on the one or more computer readable storage mediums collectively executable by a data processing system to initiate operations. The operations can include training, by machine learning and using historical data, a total demand model configured to process current data and, based on processing the current data, output first data indicating a predicted future total demand for a product. The operations also can include training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 depicts a computing environment according to an embodiment of the present invention.

FIG. 2 depicts a block diagram illustrating machine training of a model according to an embodiment of the present invention.

FIG. 3 depicts a block diagram illustrating generation of a price matrix according to an embodiment of the present invention.

FIG. 4 depicts a block diagram illustrating a process of applying machine learning to models and using the models to generate a price matrix according to an embodiment of the present invention.

FIG. 5 depicts a chart comparing results of predicting sales of a service, according to an embodiment of the present invention, with actual sales of that service.

FIG. 6 depicts a chart comparing results of predicting demand for a service, according to an embodiment of the present invention, with actual demand for that service.

FIG. 7 is a flowchart depicting a method of training demand models according to an embodiment of the present invention.

### DETAILED DESCRIPTION

This disclosure relates to machine learning, as well as optimization and application of machine learning artificial intelligence (AI) models. In this regard, the arrangements described herein are directed to computer technology, and provide an improvement to computer technology. Specifically, the present arrangements improve machine learning as applicable to optimizing prices for products to optimize revenue over a selling horizon. Such process involves machine learning optimized AI models that analyze an impact of pricing on demand given partially observed data, for example sales and endogenous sales trends.

The AI models can be time series models, for example Autoregressive Distributed Lag (ARDL) models, autoregressive integrated moving average (ARIMA) models, Multinomial Logit (MNL) models, etc. Compared to the traditional time series models in which all predicting variables must be known to make predictions, the arrangements described herein unable use of unknown decision variables, such as future prices in a time series, and forecast the optimal decision making and corresponding outcomes over time. The AI models can learn demand growth in terms of price changes and other dynamic factors in time series. The AI models also can learn the impact of dynamic pricing from competitors, including observable competitive prices with unobservable competitive demands. The AI models can optimize price matrices to maximize revenue and profit. Such optimization can include recursive optimization with demands in time series and can provide optimal dynamic pricing over multiple time periods. Accordingly, use of the AI models can enable forecasting of the overall impact of dynamic decisions, including both observable and unobservable effects and corresponding outcomes.

Multi-step learning algorithms can be used to train the AI models, for example to learn demand change in terms of trend, seasonality, break, minimum available prices, etc. Further, the multi-step learning algorithms can be used to learn relative demand change of any target class of a product in terms of each observable price change, for example a change in a self-price, prices of other classes (e.g., internal price substitution), prices of competitors (e.g., external price substitution), etc. By focusing on the change on demand, estimation of total demand, including both observable and unobservable demands, can be circumvented. Instead, such demands can be predicted using the AI models. Further, by adopting time series models, a choice model that requires estimating the likelihood of unobservable choices can be circumvented. Instead, total demand changes, including the changes from both observable and unobservable demands, can be predicted using the AI models. Further, using the AI models described herein, independence of irrelevant alternatives (IIA) properties in MNL models can be avoided.

The arrangements described herein can be implemented to predict demand growth and optimizing pricing by logistics service providers (e.g., airlines, railways, ground transportation providers, etc.), event organizers (e.g., concert organizers, sporting event organizers, convention organizers, etc.), as well as any organization that desires to further dynamically optimize their decisions based on time-series forecasts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as model optimizer 200 and price optimizer 300. In addition to blocks 200, 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, block 200 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

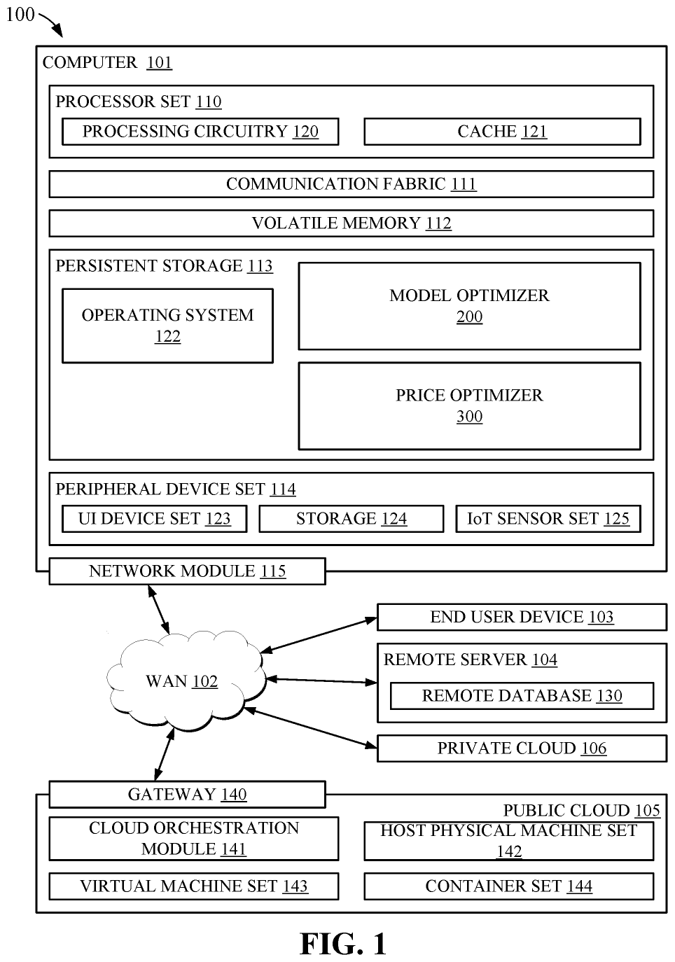

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113, and at least some of the instructions for performing the inventive methods may be stored in block 300 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in blocks 200, 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

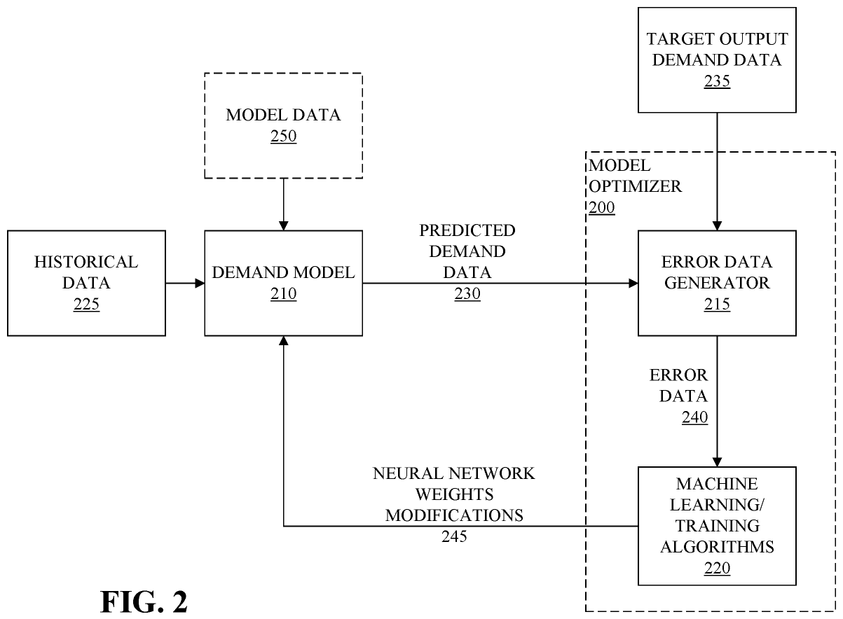

FIG. 2 depicts a block diagram illustrating machine training of a model, for example demand model 210, using model optimizer 200 according to an embodiment of the present invention. Model optimizer 200 can include error data generator 215 and machine learning/training algorithms 220 configured to train AI models, such as demand models described herein. The AI models can be forecasting models trained to estimate impact, on both observable and unobservable effects, of known and/or unknown decision variables and other observable explanatory variables over multiple future time periods.

In operation, demand model 210 can receive, as input training data for machine learning, historical data 225. Historical data 225 can include, for example, observed sales for each product, competitor's prices for competing products and/or services, external data, etc. The external data can include both structured and unstructured data. Structured data can include, for example, historical decisions, e.g., pertaining product pricing for one or more classes of the product for one or more periods, and results corresponding to the historical decisions and other observable explanatory variables. The historical decisions and results may be partially observed, influencers including decision variables and other explanatory variables, which are recorded in a time series manner, etc. Unstructured data can include results of performing natural language processing on media content (e.g., news, social media, event information, etc.) which may have an impact on decisions over time. Historical data 225 can be granular in nature. For example, historical data 225 can include data for various periods (e.g., times of day, days of the week, weekends, weeks, months, holidays, etc.), and include such data for various classes of products and/or services. Demand model 210 can be trained to select explanatory variables from historical data 225, which contain decision information, and estimate their response time. Demand model 210 also can be trained to formulate explanatory variables based on historical data 225, estimate price elasticity, estimate cross effect of competitors' price elasticity, and identify key competitors and factors.

In illustration, a service can be air travel from a particular location (e.g., origin) to a particular location (e.g., destination). The service can include various classes, e.g., coach, premium, business class, first class, etc. In this example, historical data 225 can include, for each of a plurality service periods (e.g., dates/times of flights), sales data and pricing data for each class of service. Moreover, for each service period, historical data 225 can include data indicating sales and pricing for a plurality of periods prior to the service period. For instance, for each flight, historical data 225 can indicate a number of ticket purchases for each of a plurality of days on which tickets were sold for the flight, and prices paid for those tickets, etc. Other explanatory variables may include departure time (morning or evening), indicator of days in a week (working days or weekends), purchase lead-times (days from purchase to departure), flight distance/hours, flight frequency, flight capacity, features of origin and destination, etc. Historical data 225 can be provided for each of a plurality of products and/or services.

Demand model 210 can process historical data 225 using demand algorithms, which will be described herein, and generate predicted demand data 230 based on such processing. Error data generator 215 can compare the predicted demand data 230 to target output demand data 235, and generate error data 240 indicating differences between predicted demand data 230 and target output demand data 235. Machine learning/training algorithms 220 can process the error data 240 and, based on such processing, generate neural network weights modifications 245. Machine learning/training algorithms 220 can modify coefficients of the demand model's artificial neural network (ANN) using the neural network weights modifications 245, in a process known as machine learning (or training).

The machine learning process can iterate until an objective is satisfied. Such objective can be, for example, generation of error data 240 having one or more values below one or more threshold values, the objective can be to iterate the machine learning process a threshold number of times, or the objective can be to iterate the machine learning process a threshold duration of time. Moreover, the machine learning process can be iterated in response to additional historical data 225 being acquired. Accordingly, forecasting results corresponding to optimal decisions for each period can be iteratively refreshed, and organizational objectives can be maximized over multiple future time periods.

In accordance with the present arrangements, a plurality of demand models 210 can be trained using machine learning in a hierarchical way. For example, a total demand model can be trained to predict total demand growth for a product in the first tier of machine learning, and a target demand model can use the forecast of total demand growth to train and output a class demand model for each of a plurality of classes of the product and market share changes of these classes.

The total demand model can be trained as a time series model (e.g., an ARDL model, an ARIMA model, etc.), based on observed demand, and implemented to predict total demand for a product over a future time series. The target demand model can be an be trained as a time series model (or choice model), for example an ARDL model, a MNL model, etc., for the demand of respective classes (e.g., categories) of a product, and implemented to output a respective class demand predict demand for each class of the product over a future time series. In illustration, the total demand model can predict total demand growth for air travel for specific future time periods (e.g., hours and/or days). The target demand models can predict demand growth or market share change for different travel options (e.g., coach, premium, business class, first class, etc.) for the specific future time periods. In one or more embodiments, the total demand model can be one type of AI model, while the target demand model can be another type of AI model. For example, ARIMA and ARDL models can be used to forecast total demand growth, ARDL and MNL models can be used to predict market share changes of target demands, etc.

By way of example, the total demand model can predict a change in total demand De for travel in a time series t, e.g., for t∈[0, T], where T is the departure day. The total demand De can include demand on all channels on day t, including realized demand, lost demand and demands to competitors. The ANN of the total demand model can implement the following algorithm to determine the total demand growth, which can be measured by the difference between the log values of current and previous demands:

$$ln {D}_{t} - ln {D}_{t - 1} = {α}_{1} + {\sum }_{l = 1}^{L - 1} {α}_{2 , l} ( ln {D}_{t - l} - ln {D}_{t - l - 1} ) + {α}_{3} θ ( Δ T ) + {α}_{4} {𝕀}_{weekend} + {α}_{5} {p}_{t} + {α}_{6} {NLP}_{t - l} \qquad Equation 1$$

where:
t: Purchase day.
Dₜ: Total observed sales on day t.
l=1, . . . , L−1: Lag of time series, e.g., L=7 days.
ΔT=T−t: The number of days left before the departure.
θ(ΔT): Demand pattern when approaching to departure, where ΔT=T−t.
pₜ: Price on day t.
[symbol] _{weekend}: Seasonality demand factors, for example, whether it is a weekend, holiday, etc.
NLP: Demand factors based media content.
α: The coefficients of the model calculated during machine learning.
   The term L−1 can be autoregressive, considering L−1 past demand growth/decline rates for any L>1. The price pₜ can be a minimum price, a weighted price average, or the like. Regarding the demand pattern θ(ΔT), demand may reach a peak a certain time before departer, e.g., when ΔT is 10 days to departure. Demand may decrease after reaching its peak, e.g., when ΔT is too close to the departure, due to the customer expectations of capacity limit. The seasonality demand factors for [symbol] _{weekend} can include factors for season of the year, day of the week, etc. In illustration, demand may surge for travel around holidays, demand may surge for travel to leisure destinations on weekends (especially long weekends), and demand may surge for travel to business destinations on Mondays. NLP signals can be determined, for example, by performing natural language processing on media content, and correlating words and/or phrases, as well as the frequency at which such words and/or phrases occur in the media, with demand for travel. For example, a destination with football team going to playoffs will increase the demand before the game.

The coefficients α can represent the following demand factors:
α₁: Intercept.
α₂: Effect of the previous growth of demand, l=1, . . . , L−1.
α₃: Demand pattern when approaching to departure, where ΔT=T−t.
α₄: Impact of seasonality on demand growth.
α₅: Effect of pricing on demand growth.
α₆: Effect of media on demand growth.

The target demand model can output class demand models, each of which predicts a change in target demand \hat{D}ₜ for travel for a respective observable class of travel (e.g., coach, premium, business class, first class, etc.). Each target demand model can use output by the total demand model and scale the demand for each class of travel. In illustration, the target demand model can use the prediction results of the total demand model to predict a probability of a change in choice. In this regard, in addition to the historical data 225, model data 250 generated by the trained total demand model (e.g., as predicted data 230) can be provided as input to the target demand model during training of the target demand model. For a class i, the ANN of the target demand model can implement the following algorithm, which estimates price-sensitive market share changes, to determine the predicted demand:

$$ln \frac{{d}_{t}^{i}}{{\hat{D}}_{t}} - ln \frac{{d}_{t - 1}^{i}}{{\hat{D}}_{t - 1}} = {β}_{1} + {β}_{2}^{i} {\sum }_{l = 1}^{L - 1} ( ln \frac{{d}_{t - l}^{i}}{{\hat{D}}_{t - l}} - ln \frac{{d}_{t - l - 1}^{i}}{{\hat{D}}_{t - l - 1}} ) + {β}_{3} {θ}^{i} ( Δ T ) + {β}_{4}^{i} \frac{{p}_{t}^{i} - {p}_{t - 1}^{i}}{{p}_{t - 1}^{i}} + {\sum }_{j \neq i} {β}_{5}^{j , i} \frac{{p}_{t}^{j} - {p}_{t - 1}^{j}}{{p}_{t - 1}^{j}} + {β}_{6}^{c} \frac{{p}_{t - 1}^{c} - {p}_{t - 1}^{c , i}}{{p}_{t - 1}^{c , i}} ϕ ( \frac{\vert {p}_{0}^{c , i} - {p}_{0}^{i} \vert}{{p}_{0}^{c , i}} ) \qquad Equation 2$$

where:
\hat{D}ₜ: Specific output from equation 1. Forecast value of total demand.
p₀: Initial value of prices, the price at day 0 when booking is started.
dₜⁱ: The demand for class i on day t
L: Time lag of impact, for example, 7 days.
pₜⁱ: Price of class i on day t
pₜ^{c,i}: Competitor's price on day t for class i.
β: The coefficients of the model adjusted by modified by network weights modifications during machine learning.
θⁱ(ΔT): Demand pattern for class i when approaching to departure, where ΔT=T−t.

$$ϕ ( \frac{\vert {p}_{0}^{c , i} - {p}_{0}^{i} \vert}{{p}_{0}^{c , i}} )$$

A decreasing function, (e.g., Kernel function).
   With regard to granularity, for each class of one origin/destination (OD) pair, all of the observed sales on one day that have the same departure day can be aggregated. In this example, ln (\hat{D}ₜ)−ln (\hat{D}ₜ₋₁) is the forecasted growth of total demand from period t−1 to period t. Accordingly, ln

$$\frac{{d}_{t}^{i}}{{\hat{D}}_{t}} - ln \frac{{d}_{t - 1}^{i}}{{\hat{D}}_{t - 1}}$$

is change of market share of class i from period t−1 to period t. These growth and change are measured by the difference of log value, which can be converted to the percentage growth rate by a one-to-one mapping.

The coefficients β can represent the following demand factors:
β₁: Intercept.
β₂ⁱ: Effect of the previous changes of market share of class i, l=1, . . . , L−1.
β₃: Market share pattern when approaching to departure for target markets, where ΔT=T−t.
β₄ⁱ: Effect of self-price change on demand class i.
βₛ^{j,i}: Effect of cross-price change on demand class i.
β₆^{c}: Effect of external competitor price change on demand class i.

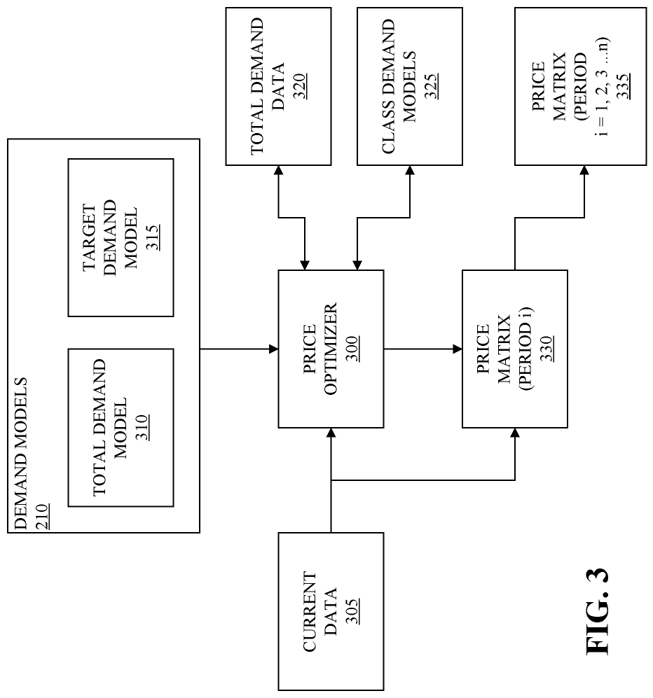

FIG. 3 depicts a block diagram illustrating generation of a price matrix according to an embodiment of the present invention. Price optimizer 300 can be executable on a same computer 101 as model optimizer 200, or can be executable on another computer. Price optimizer 300 can receive current data 305 and demand models 210, including total demand model 310 and target demand model 315. Current data 305 can include, for example, observed sales for each product, competitor's prices for competing products and/or services, external data, etc. The external data can include, for example, results of performing natural language processing on media content. The external data can include both structured and unstructured data. Structured data can include, for example, influencers including decision variables and other explanatory variables, which are recorded in a time series manner, etc. Unstructured data can include results of performing natural language processing on media content (e.g., news, social media, event information, etc.) which may have an impact on decisions over time. Current data 305 can be granular in nature. For example, current data 305 can include data for various periods (e.g., times of day, days of the week, weekends, weeks, months, holidays, etc.), and include such data for various classes of products and/or services.

In illustration, a service can be air travel from a particular location to a particular location. The service can include various classes, e.g., coach, premium, business class, first class, etc. In this example, current data 305 can include, for each of a plurality service periods (e.g., dates/times of flights), data indicating sales and pricing for each class of service. Moreover, for each service period, current data 305 can include data indicating sales and pricing for a plurality of periods prior to the service period. For instance, for each scheduled flight that has not yet taken place, current data 305 can indicate a number of ticket purchases for each of a plurality of days on which tickets were sold for the flight, and prices paid for those tickets. Current data 305 can be provided for each of a plurality of products and/or services.

Price optimizer 300 can input current data 305 to total demand model 310 to generate total demand data 320. Total demand model 310 can select explanatory variables from current data 305, which contain decision information, and estimate their response time. Total demand model 310 also can formulate explanatory variables based on current data 305, estimate price elasticity, estimate cross effect of competitors' prices, and identify key competitors and factors.

Price optimizer 300 can input current data 305 and total demand data 320 to target demand model 315 which, in response, can output a respective class demand model 325 for each class of the product. For a first class, price optimizer 300 can process the class demand model 325 for that class and generate price matrix 330 for period i. Price matrix 330 can indicate a predicted customer demand for that class for period i based on equation 2, previously discussed. Price matrix 330 also can indicate a predicted price for that class for period i that maximizes expected revenue for the product based on equation 3, below. Price optimizer 300 can generate price matrix 335, and add data from price matrix 330 to price matrix 335, including the predicted demand data and predicted price data. Price optimizer 300 again can process the class demand model 325 to generate price matrix 330 for a next period t+1, and add that data to price matrix 335. Price optimizer 300 can continue iterating that process until price matrix 335 includes predicted demand data and predicted pricing data for each desired period (e.g., for the next week, the next two weeks, the next month, etc.) for the class of product. Price optimizer 300 can repeat this process for each class of the product using the respective class demand model 325 for that class, with the exception of generating price matrix 335 if price matrix 335 already has been generated for the product using the current data 305.

Accordingly, the data in price matrix 335 can indicate demand for various classes (e.g., categories) of a product for various periods, as well as pricing (e.g., suggested pricing) for each category and each period. In this regard, price matrix 335 can serve to provide both a forecast for demand and price optimization for that demand. In illustration, the pricing can be optimized to maximize expected revenue from the product for the determined demand. In the case that multiple products and/or services are offered, price optimizer 300 can generate for each specified product a respective price matrix 335.

To generate predicted demand data and predicted price data for each price matrix 330, price optimizer 300 can solve the following optimization problem to find (e.g., myopically) the optimal price for the class of the product for a particular period (e.g., on day t), given by following equation 3:

$${max}_{{p}_{t}^{i} , {d}_{t}^{i}} : {\sum }_{i = 0}^{2} {d}_{t}^{i} {p}_{t}^{i} \qquad Equation 3$$

wherein equation 3 is maximizing total expected revenue of all classes, for example, three classes indexed by i=0, 1, 2, etc., subject to the estimate price-sensitive market share changes given by equation 2, and where:
pₗ≤pₜⁱ≤pᵤ: pricing to be optimized in period t, under the constraints of upper- and lower-bounds
pₜⁱ≤pₜ^{j}: Cross-product class-price relationships, for any i<j
dₜⁱ≤Sₜⁱ: Product availability constraints
p_{τ}ⁱ, d_{τ}ⁱ, and \hat{D}_{τ}, τ<t are given and known and wherein,
pₜⁱ: Predicted price of class i on day t
pₗ: Lower price limit
pᵤ: Upper price limit
pₜ^{j}: Predicted price for class j on day t, with pₜⁱ≤pₜⁱ for any i<j
dₜⁱ: demand of class i, as a function of variables known before period t, and decision variables in period t, which is specified by Equation 2.
Sₜⁱ: number of product available in class i in period t.
pₜⁱ and pₜ^{j}: pricing decisions to be optimized in period t.
\hat{D}ₜ: Specific output from equation 1. Estimated total demand in period t, as a function of all the explanatory variables and decision variables before period t. The coefficients β are the coefficients optimized using machine learning for equation 2.

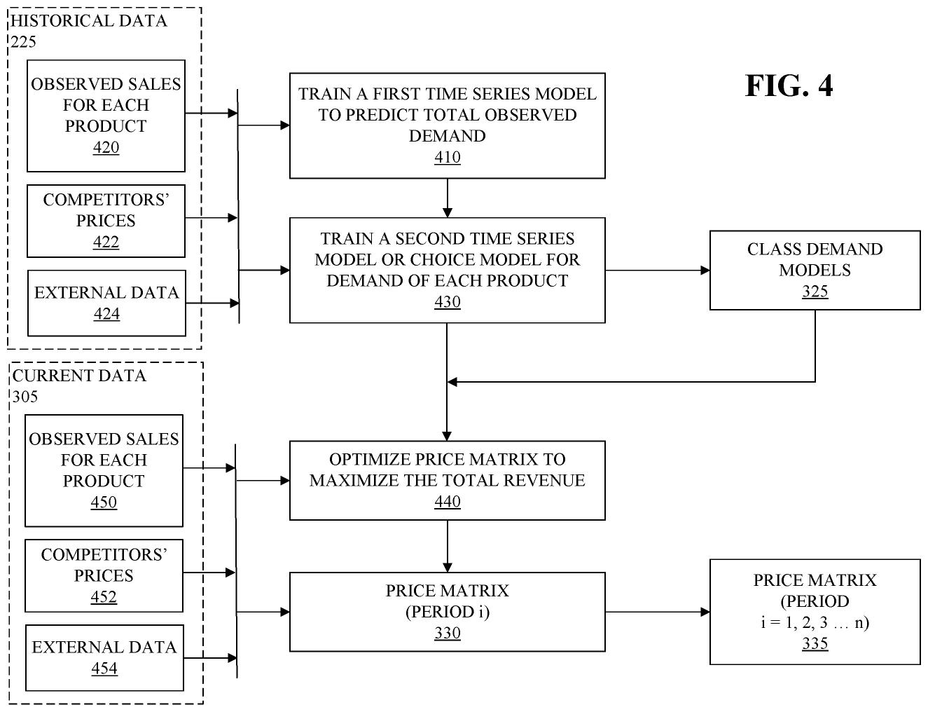

FIG. 4 depicts a block diagram illustrating a process of applying machine learning to models and using the models to generate a price matrix according to an embodiment of the present invention.

At step 410 model optimizer 200 can train a first-tier time series model, for example total demand model 310, to predict total observed demand for at least one product. Model optimizer 200 can train the first time series model using historical data 225. Historical data 225 can include, for example, historically observed sales 420 for each of a plurality of products and/or services, historical competitors' prices 422 for the plurality of products and/or services and historical external data 424. The present arrangements are not limited in this regard, though, and the historical data 225 can include any other suitable form of data.

At step 430 model optimizer 200 can train a second-tier time series model or choice model, for example target demand model 315, for demand of each product. In illustration, model optimizer 200 can train target demand model 315 to output a respective class demand model 325 for each class of the product. Each class demand model 325 can represent demand for a particular class of the product and predict a respective price for the respective class of the product for each of a plurality of future time periods that maximizes expected revenue for the product. In Equation 3, dₜⁱ is the demand of class i, obtained in Equation 2, which included all explanatory and decision variables known before period t, and decision variables unknown (e.g. pₜⁱ and pₜ^{j}) in period t. After solving the constrained optimization problem of Equation 3, the optimal pricing decisions pₜⁱ and pₜ^{j} can be obtained, and thereafter used as predictive variables in Equation 1 and Equation 2 for the next period t+1. Next, the optimal decisions (pₜⁱ and pₜ^{j}) obtained in period t can be used to forecast the total demand Dₜ₊₁ in period t+1, use the forecasted value \hat{D}ₜ₊₁ to build up the target demand model dₜ₊₁ⁱ, and solve Equation 3 to obtain the optimal pricing decisions (pₜ₊₁ⁱ and pₜ₊₁^{j}) in period t+1. Such iterative joint forecasting and optimization can continue in period t+1, t+2, . . . , up to period T, the end of a product lifecycle, for example, a departure day of a flight. To this end, the optimal decision making and corresponding outcomes can be forecasted iteratively over multi-periods through joint machine learning and dynamic optimization in our method.

At step 440 price optimizer 300 can optimize price matrix 330 to maximize total revenue for a class of a product for any period, and add data from price matrix 330 to price matrix 335. Price optimizer can optimize price matrix 330 by applying the class demand models 325 to current data 305. Current data 305 can include, for example, currently observed sales 450 for each of a plurality of products and/or services, current competitors' prices 452 for the plurality of products and/or services and current external data 454. The present arrangements are not limited in this regard, though, and the current data 305 can include any other suitable form of data. Price optimizer 300 can repeat step 440 for each class of the product, using a respective class demand model 325 for each class, to generate a plurality of price matrices 330, and add data from each price matrix 330 to price matrix 335.

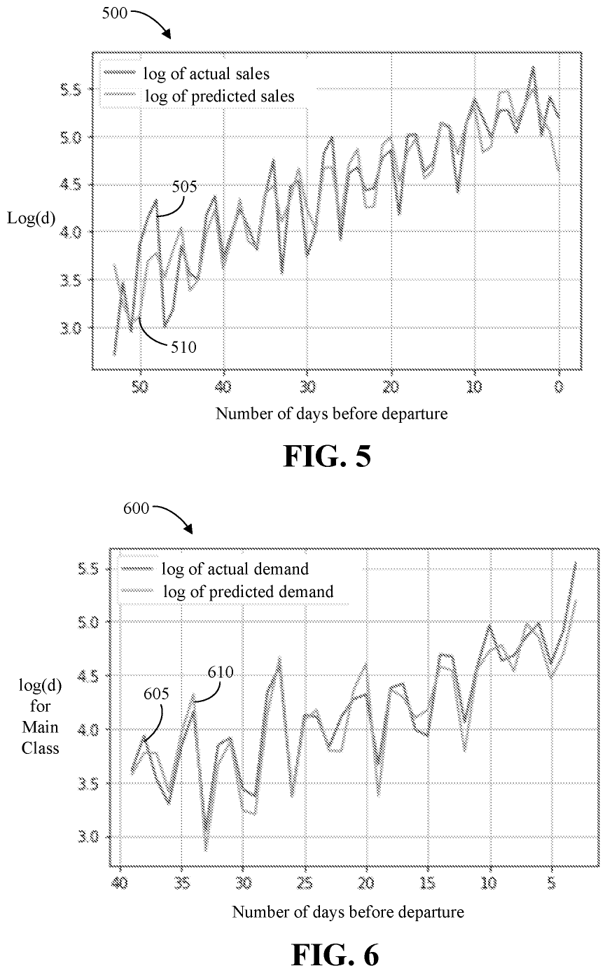

FIG. 5 depicts a chart 500 comparing results of predicting sales of a service to actual sales of that service. In this experiment, sales were for a class of service on an airplane flight, departing on a Monday. In chart 500, the horizonal axis represents the number of days before departure on which sales were predicted and occurred, and the vertical axis represents the log of total demands over time, e.g. In (Dₜ), for t=0, . . . , T. Trace 505 represents a log of actual sales for that airplane flight. Trace 510 represents the log of predicted sales for that flight. The mean absolute percentage error (MAPE) of the predicted results in comparison to the actual results was in 5%˜6%.

FIG. 6 depicts a chart 600 comparing results of predicting demand for a service to actual demand of that service. In this experiment, demand was for a class of service on an airplane flight, departing on a Monday. In chart 600, the horizonal axis represents the number of days before departure on which demand for main class was predicted and observed, and the vertical axis represents In (dₜ) of the demand. Trace 605 represents the log of actual demand for main class. Trace 610 represents a log of predicted demand (e.g., number of sales) for main class. The mean absolute percentage error (MAPE) of the predicted results in comparison to the actual results was slightly less than 5%.

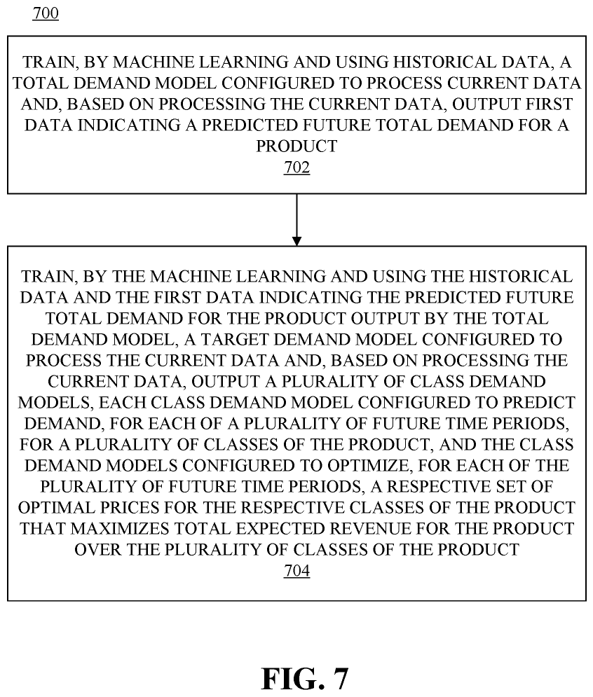

FIG. 7 is a flowchart depicting a method 700 of training demand models according to an embodiment of the present invention. The method 700 can be implemented by model optimizer 200. At step 702, model optimizer 200 can train, by machine learning and using historical data, a total demand model configured to process current data and, based on processing the current data, output first data indicating a predicted future total demand for a product. At step 704, model optimizer 200 can train, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As defined herein, the term “product” means an article of manufacture or a service provided to customers.

As defined herein, the term “customer” means a human being who purchases a product.

As defined herein, the term “total demand model” means a time series model comprising at least one artificial neural network trained, using machine learning, to predict a total demand for a product for each of a plurality of periods of time.

As defined herein, the term “target demand model” means a time series model or choice model comprising at least one artificial neural network trained, using machine learning, to output a plurality of class demand models that, collectively, predict a demand for a plurality of classes of a product for each of a plurality of periods of time.

As defined herein, the term “class demand model” means a data structure indicating demand for a particular class of a product that comprises a plurality of classes.

As defined herein, the term “output” means storing in memory elements, writing to display or other peripheral output device, sending or transmitting to another system, exporting, or similar operations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
training, by machine learning implemented using a processor and using historical data, a total demand model configured to process current data and, based on processing the current data, output first data indicating a predicted future total demand for a product; and
training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

2. The method of claim 1, wherein a price optimizer adds to a price matrix, for the plurality of respective classes of product for each of the plurality of future time periods, the respective optimal prices for the plurality of classes of the product that jointly maximize total expected revenue for the product.

3. The method of claim 2, wherein the price optimizer adds to the price matrix, for each respective class of product for each of the plurality of future time periods, the predicted demand for the class of the product.

4. The method of claim 1, wherein the historical data comprises external data comprising historical decisions and results corresponding to the historical decisions pertaining to pricing of the product and results corresponding to the historical decisions.

5. The method of claim 1, wherein the historical data comprises results of performing natural language processing on media content.

6. The method of claim 1, wherein the target demand model estimates price-sensitive market share changes to predict the demand.

7. The method of claim 1, wherein each of the future time periods is a time period prior to a period of service provide by the product.

8. A system, comprising:
a processor programmed to initiate executable operations comprising:
training, by machine learning and using historical data, a total demand model configured to process current data and, based on processing the current data, output first data indicating a predicted future total demand for a product; and
training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

9. The system of claim 8, wherein a price optimizer adds to a price matrix, for the plurality of respective classes of product for each of the plurality of future time periods, the respective optimal prices for the plurality of classes of the product that jointly maximize total expected revenue for the product.

10. The system of claim 9, wherein the price optimizer adds to the price matrix, for each respective class of product for each of the plurality of future time periods, the predicted demand for the class of the product based on the optimal prices for the respective classes.

11. The system of claim 8, wherein the historical data comprises external data comprising historical decisions and results corresponding to the historical decisions pertaining to pricing of the product and results corresponding to the historical decisions.

12. The system of claim 8, wherein the historical data comprises results of performing natural language processing on media content.

13. The system of claim 8, wherein the target demand model estimates price-sensitive market share changes to predict the demand.

14. The system of claim 8, wherein each of the future time periods is a time period prior to a period of service provide by the product.

15. A computer program product, comprising:
one or more computer readable storage mediums having program code stored thereon, the program code stored on the one or more computer readable storage mediums collectively executable by a data processing system to initiate operations including:
training, by machine learning and using historical data, a total demand model configured to process current data and, based on processing the current data, output first data indicating a predicted future total demand for a product; and
training, by the machine learning and using the historical data and the first data indicating the predicted future total demand for the product output by the total demand model, a target demand model configured to process the current data and, based on processing the current data, output a plurality of class demand models, each class demand model configured to predict demand, for each of a plurality of future time periods, for a plurality of classes of the product, and the class demand models configured to optimize, for each of the plurality of future time periods, a respective set of optimal prices for the respective classes of the product that maximizes total expected revenue for the product over the plurality of classes of the product.

16. The computer program product of claim 15, wherein a price optimizer adds to a price matrix, for the plurality of respective classes of product for each of the plurality of future time periods, the respective optimal prices for the plurality of classes of the product that jointly maximize total expected revenue for the product.

17. The computer program product of claim 16, wherein the price optimizer adds to the price matrix, for each respective class of product for each of the plurality of future time periods, the predicted demand for the class of the product.

18. The computer program product of claim 15, wherein the historical data comprises external data comprising historical decisions and results corresponding to the historical decisions pertaining to pricing of the product and results corresponding to the historical decisions.

19. The computer program product of claim 15, wherein the historical data comprises results of performing natural language processing on media content.

20. The computer program product of claim 15, wherein the target demand model estimates price-sensitive market share changes to predict the demand.
